(19) United States
(12) Patent Application Publication
(10) Pub. No.: US 2021/0110322 A1
(43) Pub. Date: Apr. 15, 2021

(54) Computer Implemented Method for Detecting Peers of a Client Entity

(71) Applicant: Visa International Service Association, San Francisco, CA (US)

(72) Inventors: Amrendra Narayan Jha, Bangalore (IN); Animesh Tripathy, Bangalore (IN); Vijayendra Singh, Bangalore (IN); Santosh Kumar KVS, Bangalore (IN)

(21) Appl. No.: 16/597,204

(22) Filed: Oct. 9, 2019

(51) Int. Cl. G06Q 10/06; G06Q 30/02

(52) U.S. Cl. CPC G06Q 10/0637; G06Q 30/0201

(57) ABSTRACT

The present disclosure is related to a field of data analytics using machine learning techniques that discloses system, and a computer implemented method for detecting peers of a client entity in real-time. A peer analyzing system retrieves and shortlists target entities based on transaction data related to target entities and input data received from client entity. Further, the peer analyzing system may generate a plurality of clusters of the shortlisted entities by applying a predefined cluster compliance rule. Furthermore, a query point of plurality of parameters of transaction data for each of the plurality of clusters may be determined based on normalized values of corresponding plurality of parameters determined for the client entity. Further, the peer analyzing system may determine peers of the client entity based on relevance score and proximity score determined for each of the plurality of clusters based on the query point and normalized values of the plurality of parameters.

### BACKGROUND

### Technical Field

The present disclosure relates to peer analysis. Particularly, but not exclusively, the present disclosure relates to a system and a method for detecting peers of a client entity in real-time.

### Technical Considerations

Nowadays, there are numerous entities under each industry segment, as an example, entities related to footwear, restaurants, clothing, furniture, and the like. Due to large number of such entities under each industry segment, there exists competition at every level between the entities belonging to a particular industry segment. To survive in this competitive environment, it becomes extremely critical for the entities to continually perform competitive analysis. Generally, competitive analysis between entities involves relative assessment of an entity with position of peers/competitors and self-assessment of the entity. Therefore, results of the competitive analysis help the entities in understanding strengths and weaknesses of their peers/competitors, which in turn enable the entities to develop marketing strategies that increase customer loyalty. In addition to the development of the marketing strategies, competitive analysis plays a major role in mergers and acquisitions of entities. Therefore, analysis of the peers/competitors of an entity is crucial.

However, the existing techniques fail to provide accurate peer analysis or competitor analysis due to the following reasons. Firstly, the existing techniques may generate only a single peer group or few combinations of peer groups for performing competitive analysis. Therefore, the peer groups considered for the competitive analysis may not be accurate. Further, the existing techniques first acquire required data from various sources and then at a later stage perform the competitive analysis offline, using the acquired data. Therefore, the competitive analysis performed by the existing techniques may be inaccurate as data continually changes and offline analysis fails to incorporate the changes occurring in real-time. Furthermore, one of the important parameters for performing competitive analysis is transaction data related to the entities. However, the existing techniques may not have a reliable real-time source of transaction data, thereby lacking crucial information required for the analysis.

Therefore, currently, there exists a need for performing competitive analysis based on accurate peer groups and reliable real-time data.

The information disclosed in this background of the disclosure section is only for enhancement of understanding of the general background of the disclosure and should not be taken as an acknowledgement or any form of suggestion that this information forms the prior art already known to a person skilled in the art.

### SUMMARY

Accordingly, provided are improved methods, systems, and computer program products for detecting peers of a client entity. Additional features and advantages are realized through the techniques of the present disclosure. Other embodiments and aspects of the disclosure are described in detail herein and are considered a part of the claimed disclosure.

In some non-limiting embodiments or aspects, provided is a computer-implemented method that may include, receiving, by a peer analyzing system, input data from a client entity. The input data may include an entity ID, an industry segment of the client entity, and a query of the client entity. Further, the method includes retrieving a plurality of target entities related to the input data and transaction data related to the plurality of target entities, in real-time. In some non-limiting embodiments or aspects, the transaction data may include entity ID, entity name, entity category, transaction volume, transaction ID, ticket size, and card count. Subsequently, the method includes shortlisting a predefined number of the plurality of target entities by sorting the plurality of target entities based on transaction volume related to the plurality of target entities. Upon shortlisting the plurality of target entities, the method includes determining normalized values of a plurality of parameters of the transaction data for each of the shortlisted entities and the client entity. Further, the method includes generating a plurality of clusters of the shortlisted entities by applying a predefined cluster compliance rule. Each of the plurality of clusters may include a unique combination of the shortlisted entities. Furthermore, the method includes determining a query point of the plurality of parameters for each of the plurality of clusters based on the normalized values of the corresponding plurality of parameters determined for the client entity. Subsequently, the method includes determining a relevance score and a proximity score of each of the plurality of clusters based on the query point of the plurality of parameters and the normalized values of the corresponding plurality of parameters determined for the client entity and each of the shortlisted entities. Finally, the method includes detecting a cluster of the shortlisted entities among the plurality of clusters based on the relevance score and proximity score of each of the plurality of clusters to detect peers of the client entity.

In some non-limiting embodiments or aspects, provided is a peer analyzing system. The peer analyzing system includes a processor and a memory communicatively coupled to the processor. The memory stores processor instructions, which, on execution, causes the processor to receive input data from a client entity. The input data may include an entity ID, an industry segment of the client entity, and a query of the client entity. Further, the processor is configured to retrieve a plurality of target entities related to the input data and transaction data related to the plurality of target entities, in real-time. In some non-limiting embodiments or aspects, the transaction data may include entity ID, entity name, entity category, transaction volume, transaction ID, ticket size, and card count. Subsequently, the processor is configured to shortlist a predefined number of the plurality of target entities by sorting the plurality of target entities based on transaction volume related to the plurality of target entities. Upon shortlisting the plurality of target entities, the process determines normalized values of a plurality of parameters of the transaction data for each of the shortlisted entities and the client entity. Further, the processor is configured to generate a plurality of clusters of the shortlisted entities by applying a predefined cluster compliance rule. Each of the plurality of clusters may include a unique combination of the shortlisted entities. Furthermore, the processor is configured to determine a query point of the plurality of parameters for each of the plurality of clusters based on the normalized values of the corresponding plurality of parameters determined for the client entity. Subsequently, the processor is configured to determine a relevance score and a proximity score of each of the plurality of clusters based on the query point of the plurality of parameters and the normalized values of the corresponding plurality of parameters determined for the client entity and each of the shortlisted entities. Finally, the processor is configured to detect a cluster of the shortlisted entities among the plurality of clusters based on the relevance score and proximity score of each of the plurality of clusters to detect peers of the client entity.

In some non-limiting embodiments or aspects, provided is a non-transitory computer readable medium including instructions stored thereon that when processed by at least one processor causes a peer analyzing system to perform operations comprising receiving input data from a client entity. The input data comprises an entity ID, an industry segment of the client entity, and a query of the client entity. Further, the instructions cause the processor to retrieve a plurality of target entities related to the input data and transaction data related to the plurality of target entities, in real-time. The transaction data comprises entity ID, entity name, entity category, transaction volume, transaction ID, ticket size, and card count. Furthermore, the instructions cause the processor to shortlist a predefined number of the plurality of target entities by sorting the plurality of target entities based on transaction volume related to the plurality of target entities. Subsequently, the instructions cause the processor to determine normalized values of a plurality of parameters of the transaction data for each of the shortlisted entities and the client entity. Further, the instructions cause a processor to generate a plurality of clusters of the shortlisted entities by applying a predefined cluster compliance rule. Each of the plurality of clusters comprises a unique combination of the shortlisted entities. Upon generating the plurality of clusters, the instructions cause the processor to determine a query point of the plurality of parameters for each of the plurality of clusters based on the normalized values of the corresponding plurality of parameters determined for the client entity. Further, the instructions cause the processor to determine a relevance score and a proximity score of each of the plurality of clusters based on the query point of the plurality of parameters and the normalized values of the corresponding plurality of parameters determined for the client entity and each of the shortlisted entities. Finally, the instructions cause the processor to detect a cluster of the shortlisted entities among the plurality of clusters based on the relevance score and proximity score of each of the plurality of clusters to detect peers of the client entity.

Further non-limiting embodiments or aspects are set forth in the following numbered clauses:

Clause 1: A computer-implemented method comprising: receiving, by a peer analyzing system, input data from a client entity, wherein the input data comprises an entity ID, an industry segment of the client entity, and a query of the client entity; retrieving, by the peer analyzing system, a plurality of target entities related to the input data and transaction data related to the plurality of target entities, in real-time, wherein the transaction data comprises entity ID, entity name, entity category, transaction volume, transaction ID, ticket size, and card count; shortlisting, by the peer analyzing system, a predefined number of the plurality of target entities by sorting the plurality of target entities based on transaction volume related to the plurality of target entities; determining, by the peer analyzing system, normalized values of a plurality of parameters of the transaction data for each of the shortlisted entities and the client entity; generating, by the peer analyzing system, a plurality of clusters of the shortlisted entities, by applying a predefined cluster compliance rule, wherein each of the plurality of clusters comprises a unique combination of the shortlisted entities; determining, by the peer analyzing system, a query point of the plurality of parameters for each of the plurality of clusters based on the normalized values of the corresponding plurality of parameters determined for the client entity; determining, by the peer analyzing system, a relevance score and a proximity score of each of the plurality of clusters based on the query point of the plurality of parameters and the normalized values of the corresponding plurality of parameters determined for the client entity and each of the shortlisted entities; detecting, by the peer analyzing system, a cluster of the shortlisted entities among the plurality of clusters based on the relevance score and the proximity score of each of the plurality of clusters to detect peers of the client entity.

Clause 2: The computer-implemented method of clause 1, wherein determining the relevance score comprises: determining, by the peer analyzing system, a mean deviation of the normalized values of the plurality of parameters for each of the plurality of clusters based on the normalized values of plurality of parameters of each shortlisted entity in the plurality of clusters and the query point of the corresponding plurality of parameters; and determining, by the peer analyzing system, the relevance score for each of the plurality of clusters based on the mean deviation of the normalized values of the plurality of parameters determined for each of the plurality of clusters.

Clause 3: The computer-implemented of clause 1 or 2, wherein determining the proximity score comprises: determining, by the peer analyzing system, a proximity value of the normalized values of the plurality of parameters for each of the plurality of clusters based on the normalized values of the corresponding plurality of parameters of each target entity in the plurality of clusters and the normalized values of the corresponding plurality of parameters of the client entity; and determining, by the peer analyzing system, the proximity score for each of the plurality of clusters based on the proximity value determined for each of the plurality of clusters.

Clause 4: The computer-implemented method of any of clauses 1-3, wherein the relevance score indicates degree of similarity of each of the plurality of clusters to the query of the client entity.

Clause 5: The computer-implemented method of any of clauses 1-4, wherein the proximity score indicates degree of proximity of each of the plurality of clusters to the client entity.

Clause 6: The computer-implemented method of any of clauses 1-5, wherein the query of the client entity comprises a location of the client entity and time range for the query.

Clause 7: The computer-implemented method of any of clauses 1-6, wherein the normalized values of the plurality of parameters for each of the shortlisted entities and the client entity is determined using one or more predefined min-max normalization techniques.

Clause 8: A peer analyzing system comprising: a processor; and a memory communicatively coupled to the processor, wherein the memory stores processor instructions, which, on execution, causes the processor to: receive input data from a client entity, wherein the input data comprises an entity ID, an industry segment of the client entity, and a query of the client entity; retrieve a plurality of target entities related to the input data and transaction data related to the plurality of target entities, in real-time, wherein the transaction data comprises entity ID, entity name, entity category, transaction volume, transaction ID, ticket size, and card count; shortlist a predefined number of the plurality of target entities by sorting the plurality of target entities based on transaction volume related to the plurality of target entities; determine normalized values of a plurality of parameters of the transaction data for each of the shortlisted entities and the client entity; generate a plurality of clusters of the shortlisted entities, by applying a predefined cluster compliance rule, wherein each of the plurality of clusters comprises a unique combination of the shortlisted entities; determine a query point of the plurality of parameters for each of the plurality of clusters based on the normalized values of the corresponding plurality of parameters determined for the client entity; determine a relevance score and a proximity score of each of the plurality of clusters based on the query point of the plurality of parameters and the normalized values of the corresponding plurality of parameters determined for the client entity and each of the shortlisted entities; and detect a cluster of the shortlisted entities among the plurality of clusters based on the relevance score and the proximity score of each of the plurality of clusters to detect peers of the client entity.

Clause 9: The peer analyzing system of clause 8, wherein the processor determines the relevance score by: determining a mean deviation of the normalized values of the plurality of parameters for each of the plurality of clusters based on the normalized values of plurality of parameters of each shortlisted entity in the plurality of clusters and the query point of the corresponding plurality of parameters; and determining the relevance score for each of the plurality of clusters based on the mean deviation of the normalized values of the plurality of parameters determined for each of the plurality of clusters.

Clause 10: The peer analyzing system of clause 8 or 9, wherein the processor determines the proximity score by: determining a proximity value of the normalized values of the plurality of parameters for each of the plurality of clusters based on the normalized values of the corresponding plurality of parameters of each target entity in the plurality of clusters and the normalized values of the corresponding plurality of parameters of the client entity; and determining the proximity score for each of the plurality of clusters based on the proximity value determined for each of the plurality of clusters.

Clause 11: The peer analyzing system of any of clauses 8-10, wherein the relevance score indicates degree of similarity of each of the plurality of clusters to the query of the client entity.

Clause 12: The peer analyzing system of any of clauses 8-11, wherein the proximity score indicates degree of proximity of each of the plurality of clusters to the client entity.

Clause 13: The peer analyzing system of any of clauses 8-12, wherein the query of the client entity comprises a location of the client entity and time range for the query.

Clause 14: The peer analyzing system of any of clauses 8-13, wherein the normalized values of the plurality of parameters for each of the shortlisted entities and the client entity is determined using one or more predefined min-max normalization techniques.

Clause 15: A non-transitory computer readable medium including instructions stored thereon that when processed by at least one processor causes a peer analyzing system to perform operations comprising: receiving input data from a client entity, wherein the input data comprises an entity ID, an industry segment of the client entity, and a query of the client entity; retrieving a plurality of target entities related to the input data and transaction data related to the plurality of target entities, in real-time, wherein the transaction data comprises entity ID, entity name, entity category, transaction volume, transaction ID, ticket size, and card count; shortlisting a predefined number of the plurality of target entities by sorting the plurality of target entities based on transaction volume related to the plurality of target entities; determining normalized values of a plurality of parameters of the transaction data for each of the shortlisted entities and the client entity; generating a plurality of clusters of the shortlisted entities, by applying a predefined cluster compliance rule, wherein each of the plurality of clusters comprises a unique combination of the shortlisted entities; determining a query point of the plurality of parameters for each of the plurality of clusters based on the normalized values of the corresponding plurality of parameters determined for the client entity; determining a relevance score and a proximity score of each of the plurality of clusters based on the query point of the plurality of parameters and the normalized values of the corresponding plurality of parameters determined for the client entity and each of the shortlisted entities; and detecting a cluster of the shortlisted entities among the plurality of clusters based on the relevance score and the proximity score of each of the plurality of clusters to detect peers of the client entity.

Clause 16: The medium of clause 15, wherein the instructions cause the processor to determine the relevance score by: determining a mean deviation of the normalized values of the plurality of parameters for each of the plurality of clusters based on the normalized values of plurality of parameters of each shortlisted entity in the plurality of clusters and the query point of the corresponding plurality of parameters; and determining the relevance score for each of the plurality of clusters based on the mean deviation of the normalized values of the plurality of parameters determined for each of the plurality of clusters.

Clause 17: The medium of clause 15 or 16, wherein the instructions cause the processor to determine the proximity score by: determining a proximity value of the normalized values of the plurality of parameters for each of the plurality of clusters based on the normalized values of the corresponding plurality of parameters of each target entity in the plurality of clusters and the normalized values of the corresponding plurality of parameters of the client entity; and determining the proximity score for each of the plurality of clusters based on the proximity value determined for each of the plurality of clusters.

Clause 18: The medium of any of clauses 15-17, wherein the relevance score indicates degree of similarity of each of the plurality of clusters to the query of the client entity.

Clause 19: The medium of any of clauses 15-18, wherein the proximity score indicates degree of proximity of each of the plurality of clusters to the client entity.

Clause 20: The medium of any of clauses 15-19, wherein the query of the client entity comprises a location of the client entity and time range for the query.

The foregoing summary is illustrative only and is not intended to be in any way limiting. In addition to the illustrative aspects, embodiments, and features described above, further aspects, embodiments, and features may become apparent by reference to the drawings and the following detailed description.

### BRIEF DESCRIPTION OF THE DRAWINGS

The novel features and characteristic of the disclosure are set forth in the appended claims. The disclosure itself, however, as well as a preferred mode of use, further objectives and advantages thereof, may best be understood by reference to the following detailed description of an illustrative embodiment when read in conjunction with the accompanying drawings. The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. One or more embodiments are now described, by way of example only, with reference to the accompanying figures wherein like reference numerals represent like elements and in which:

FIG. 1 shows an exemplary architecture for detecting peers of a client entity, in accordance with some non-limiting embodiments or aspects of the present disclosure;

FIG. 2A shows a detailed block diagram of the peer analyzing system for detecting peers of a client entity, in accordance with some non-limiting embodiments or aspects of the present disclosure;

FIG. 2B shows an exemplary representation of a plurality of clusters in accordance with some non-limiting embodiments or aspects of the present disclosure;

FIG. 3 shows a flow chart illustrating method steps for detecting peers of a client entity, in accordance with some non-limiting embodiments or aspects of the present disclosure; and

FIG. 4 is a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it may be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment, aspect, or implementation of the present subject matter described herein as “exemplary” is not necessarily to be construed as preferred or advantageous over other embodiments.

While the disclosure is susceptible to various modifications and alternative forms, the specific embodiment thereof has been shown by way of example in the drawings and may be described in detail below. It should be understood, however that it is not intended to limit the disclosure to the particular forms disclosed, but on the contrary, the disclosure is to cover all modifications, equivalents, and alternatives falling within the scope of the disclosure.

The terms “comprises”, “includes”, “comprising”, “including”, or any other variations thereof are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” or “includes . . . a” does not, without more constraints, preclude the existence of other elements or additional elements in the system or apparatus.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least in partially on” unless explicitly stated otherwise. The term “some non-limiting embodiments or aspects” means “one or more (but not all) embodiments or aspects of the disclosure(s)” unless expressly specified otherwise. A description of some non-limiting embodiments or aspects with several components in communication with each other does not imply that all such components are required. On the contrary, a variety of optional components is described to illustrate the wide variety of possible embodiments of the disclosure.

When a single device or article is described herein, it will be clear that more than one device/article (whether they cooperate) may be used in place of a single device/article. Similarly, where more than one device or article is described herein (whether they cooperate), it will be clear that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the disclosure need not include the device itself.

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the terms “user device” and/or “computing device” may refer to one or more electronic devices that are configured to directly or indirectly communicate with or over one or more networks. The computing device may include a computer, a desktop computer, a server, a client device, a mobile device, and/or the like. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. An “application” or “application program interface” (API) may refer to software or other data sorted on a computer readable medium that may be executed by a processor to facilitate the interaction between software components, such as a client-side front-end and/or server-side back-end for receiving data from the client. A “screen” and/or “interface” refers to a generated display, such as one or more graphical user interfaces (GUIs) with which a user may interact, either directly or indirectly (e.g., through a keyboard, mouse, etc.) on a display screen of the user device and/or computing device.

As used herein, the terms “server” and/or “processor” may refer to one or more computing devices, such as processors, storage devices, and/or similar computer components that communicate with client devices and/or other computing devices over a network, such as the Internet or private networks, and, in some examples, facilitate communication among other servers and/or client devices. It will be appreciated that various other arrangements are possible. As used herein, the term “system” may refer to one or more computing devices or combinations of computing devices such as, but not limited to, processors, servers, client devices, software applications, and/or other like components. In addition, reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

The present disclosure relates to system and computer implemented method for detecting peers of a client entity in real-time. The method comprises receiving, by a peer analyzing system, input data from a client entity. The input data may include an entity ID, an industry segment of the client entity, and a query of the client entity. Further, the peer analyzing system may retrieve a plurality of target entities related to the input data and transaction data related to the plurality of target entities in real-time. In some non-limiting embodiments or aspects, the transaction data may include entity ID, entity name, entity category, transaction volume, transaction ID, ticket size, and card count. Subsequently, the peer analyzing system may include shortlisting a predefined number of the plurality of target entities by sorting the plurality of target entities based on transaction volume related to the plurality of target entities. Upon shortlisting the plurality of target entities, the peer analyzing system may determine normalized values of a plurality of parameters of the transaction data for each of the shortlisted entities and the client entity. As an example, when three parameters of the transaction data are used for detecting peers of the client entity, the peer analyzing system may generate a normalized value of each of the three parameters. Further, the peer analyzing system may generate a plurality of clusters of the shortlisted entities by applying a predefined cluster compliance rule. Each of the plurality of clusters may include a unique combination of the shortlisted entities. Furthermore, the peer analyzing system may determine a query point of the plurality of parameters for each of the plurality of clusters based on the normalized values of the corresponding plurality of parameters determined for the client entity. Subsequently, the peer analyzing system may determine a relevance score and a proximity score of each of the plurality of clusters based on the query point of the plurality of parameters and the normalized values of the corresponding plurality of parameters determined for the client entity and each of the shortlisted entities. Upon determining the relevance score and the proximity score, the peer analyzing system may detect a cluster of the shortlisted entities among the plurality of clusters based on the relevance score and proximity score of each of the plurality of clusters to detect peers of the client entity.

The present disclosure enables detection of peers for any entity using suitable quantifiable metrics in real-time. Further, the present disclosure generates the plurality of clusters of target entities based on real-time transaction data such that every possible unique combination of the target entities is covered, while adhering to the predefined cluster compliance rule. Therefore, this feature of the present disclosure enables accurate detection of peers of the client entity in real-time. Furthermore, the present disclosure performs query based detection of peers, which means that the present disclosure enables the client entity to provide their specific requirements in the form of a query, for performing the peer analysis. Therefore, the present disclosure is flexible to cater different requirements of the client entities while performing the peer analysis in real-time. The present disclosure may also be adaptable to generate clusters of customizable sizes based on requirement of the client entity by analyzing the transaction data in real-time. Further, the present disclosure determines the peers of the client entity based on both relevance score and proximity score, thereby detecting the most accurate peers of the client entity in view of the degree of similarity of the plurality of clusters to query of the client entity and the degree of proximity of the plurality of clusters to client entity. Furthermore, since a cluster refers to different combinations of the shortlisted entities relevant to the query identified via entity identifiers, the present disclosure enables peer selection per individual cluster or combination of different clusters.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

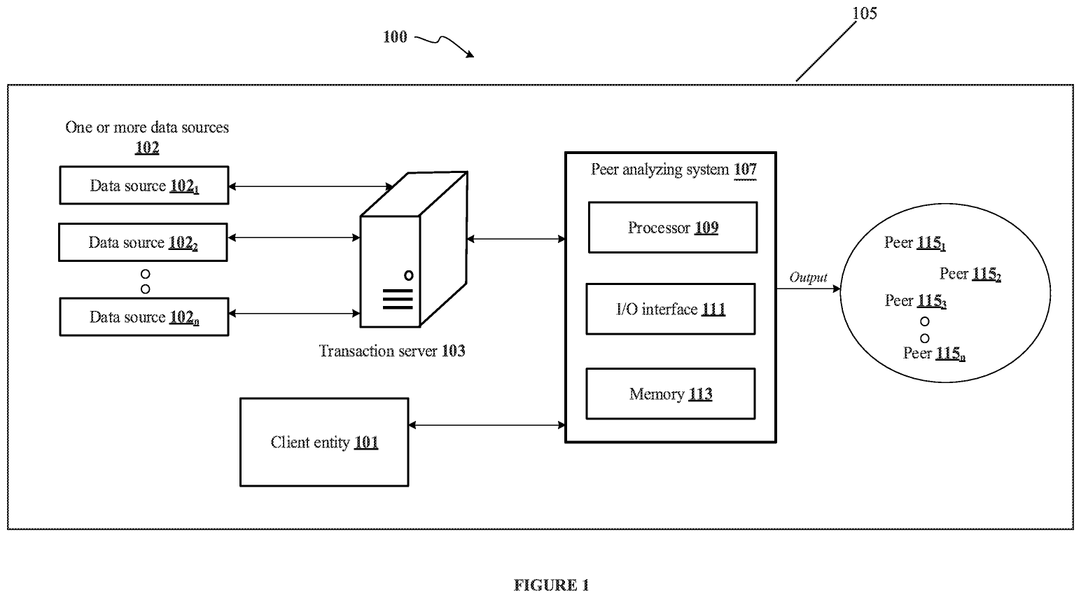

FIG. 1 shows an exemplary architecture 100 for detecting peers of a client entity, in accordance with some non-limiting embodiments or aspects of the present disclosure. In some non-limiting implementations, the architecture 100 may include a client entity 101, data source 102₁ to 102ₙ (also referred as one or more data sources 102), a transaction server 103, a communication network 105, a peer analyzing system 107 and peers 115₁ to 115ₙ (also referred as one or more peers 115 or peers 115). In some non-limiting embodiments or aspects, the client entity 101 may be an entity requesting a peer analyzing system 107 to detect one or more peers 115 of that entity. The client entity 101 may be associated with the peer analyzing system 107 via the communication network 105. As an example, the communication network 105 may be a wired communication network, a wireless communication network, or a combination of the wired and wireless communication network. Further, the peer analyzing system 107 may be associated with the transaction server 103 via the communication network 105. In some non-limiting embodiments or aspects, the transaction server 103 may include, but not be limited to, transaction data related to one or more entities. In this disclosure, the phrase “one or more entities” may refer to all the entities, irrespective of the entity being a client entity or a target entity. As an example, the transaction data may include, but not be limited to, entity ID, entity name, entity category, transaction volume, transaction ID, ticket size, and card count. In some non-limiting embodiments or aspects, entity ID may uniquely identify the entity, the entity name may be a registered name of the entity, the entity category may be a classification of business of the entity based on type of goods and services provided by the entity, transaction volume may be total number of transactions processed in an entity account, transaction ID may be a unique identifier assigned for each transaction, ticket size may be a transaction amount or a transaction count, and card count may be a total number of cards, such as credit card, debit card, and the like, used for performing the transaction with the entity. In some non-limiting embodiments or aspects, the transaction server 103 may receive the transaction data in real-time from one or more data sources 102. As an example, the one or more data sources 102 may be one or more entities at which customers complete a transaction. In some non-limiting embodiments or aspects, the transaction server 103 may receive the transaction data when a customer makes a payment to an entity. As an example, when the customer purchases a product of the entity or utilizes services of the entity, the customer may initiate an electronic payment with the entity. The transaction server 103 may receive an authorization request along with the transaction data from the corresponding entity for authorizing the transaction, which is further forwarded to a card issuing entity such as a bank. The card issuing entity may authorize the transaction, which is further forwarded to the entity by the transaction server 103 for completing the transaction. The transaction server 103 thus stores the transaction data received from each of the one or more data sources 102.

Further, in some non-limiting embodiments or aspects, the peer analyzing system 107 may include a processor 109, an input/output (I/O) interface 111, and a memory 113. The I/O interface 111 may be configured to receive input data from a client entity 101. In some non-limiting embodiments or aspects, the input data may include, but not be limited to, an entity ID of the client entity 101, an industry segment of the client entity 101, and a query of the client entity 101. In some non-limiting embodiments or aspects, the client entity ID may uniquely identify the client entity 101 requesting to detect the one or more peers 115. Further, the client entity 101 may be operating in multiple industry segments. Therefore, mentioning the industry segment of the client entity 101 defines the industry segment for which the client entity 101 is requesting to detect the one or more peers 115. Further, the query of the client entity 101 may include specifics related to what kind of peers the client entity 101 is requesting. As an example, the query may be “provide weekend trends of entities in industry segment ‘A’ observed in last three months”. In a further example, the query may be “what is the trend of my peers in last two years”. Further, the query of the client entity 101 may include, but not be limited to, a location of the client entity 101 and time range for the query. As an example, the time range of the query may be yearly such as last five years, monthly such as previous month or previous two months, quarterly such as first quarter or second quarter of the year, and the like. In some non-limiting embodiments or aspects, the query of the client entity 101 may also include a location in which the client entity 101 wants the one or more peers 115 to be detected.

Upon receiving the input data, the processor 109 may retrieve a plurality of target entities based on the input data and the transaction data related to the plurality of target entities, in real-time. In some non-limiting embodiments or aspects, the target entities may be potential peers of the client entity 101 in the industry segment of the client entity 101. Further, the processor 109 may shortlist a predefined number of the plurality of target entities. In some non-limiting embodiments or aspects, the processor 109 may shortlist the plurality of target entities by sorting the plurality of target entities based on transaction volume related to the plurality of target entities. In some other embodiments, the processor 109 may sort the plurality of target entities based on any other parameter of the transaction data, other than transaction volume. In yet other embodiments, the processor 109 may shortlist the plurality of target entities based on any other predefined technique other than sorting technique.

Further, the processor 109 may determine normalized values of a plurality of parameters of the transaction data for each of the shortlisted entities and the client entity 101. As an example, since transaction volume is one of the parameters of the transaction data, the processor 109 may determine a normalized transaction volume for each of the plurality of target entities based on transaction volume of each of the plurality of target entities, and a normalized transaction volume for the client entity 101 based on the transaction volume of the client entity 101. Similarly, the processor 109 may determine a normalized ticket size for each of the plurality of target entities based on ticket size of the plurality of target entities, and a normalized ticket size for the client entity 101 based on the ticket size of the client entity 101. In some non-limiting embodiments or aspects, the processor 109 may determine the normalized values of the plurality of parameters for each of the shortlisted entities and the client entity 101 using one or more predefined min-max normalization techniques. In some non-limiting embodiments or aspects, the processor 109 may dynamically select the plurality of parameters of the transaction data required for detecting the one or more peers 115, based on the query of the client entity 101. In some other embodiments, the plurality of parameters of the transaction data required for detecting the one or more peers 115 may be predefined.

Further, the processor 109 may generate a plurality of clusters of the shortlisted entities by applying a predefined cluster compliance rule. In some non-limiting embodiments or aspects, each of the plurality of clusters may include a unique combination of the plurality of target entities shortlisted by the processor 109. Hereinafter, the plurality of target entities shortlisted by the processor 109 may be referred as “shortlisted entities”. As an example, the predefined cluster compliance rule may include, but not be limited to, Rule 5/50. According to the Rule 5/50, each cluster may include a unique combination of five shortlisted entities such that revenue generated by each of the five shortlisted entities does not exceed 50% of the revenue generated by the client entity 101. Therefore, at this stage, the processor 109 may eliminate the shortlisted entities that fail to comply with the predefined cluster compliance rule. In some non-limiting embodiments or aspects, the predefined cluster compliance can be any other rule/Attorney criteria, other than the Rule 5/50 explained in the above example, which the processor 109 may apply on the shortlisted entities to form the plurality of clusters.

Further, the processor 109 may determine a query point of the plurality of parameters for each of the plurality of clusters based on the normalized values of the corresponding plurality of parameters determined for the client entity 101. As an example, when the parameter considered for normalization is “transaction volume”, the processor 109 may initially determine the normalized transaction volume. Further, the processor 109 may determine a query point of the transaction volume for each of the plurality of clusters based on the normalized transaction volume determined for the client entity 101. In some non-limiting embodiments or aspects, the query point of the plurality of parameters may signify a group calculation, which is further used for determining a relevance score and a proximity score. In some non-limiting embodiments or aspects, group calculation may specify grouping shortlisted entities based on an upper bound of the plurality of parameters used for performing the peer analysis.

Further, the processor 109 may determine a relevance score and a proximity score of each of the plurality of clusters based on the query point of the plurality of parameters and the normalized values of the corresponding plurality of parameters determined for the client entity 101 and each of the shortlisted entities. In some non-limiting embodiments or aspects, the relevance score may indicate a degree of similarity of each of the plurality of clusters to the query of the client entity 101. In some non-limiting embodiments or aspects, the proximity score may indicate a degree of proximity of each of the plurality of clusters to the client entity 101. Further, the processor 109 may detect a cluster of the shortlisted entities among the plurality of clusters based on the relevance score and proximity score of each of the plurality of clusters. In some non-limiting embodiments or aspects, the shortlisted entities that are part of the detected cluster may be considered as one or more peers 115 of the client entity 101.

In some non-limiting embodiments or aspects, upon detecting the one or more peers 115 of the client entity 101, the processor 109 may generate an analysis report for the client entity 101. As an example, the analysis report may provide analysis such as “Growth rate of peers of the client entity is 2%, while growth rate of the client entity is 5%”, “Customers of Peer ‘A’ have increased by 10% in the last 2 years, while customers of Peers ‘B’, ‘C’, and ‘D’ have increased by 15%”, and the like. Further, the processor 109 may maintain anonymity of the peers in the analysis report provided to the client entity 101.

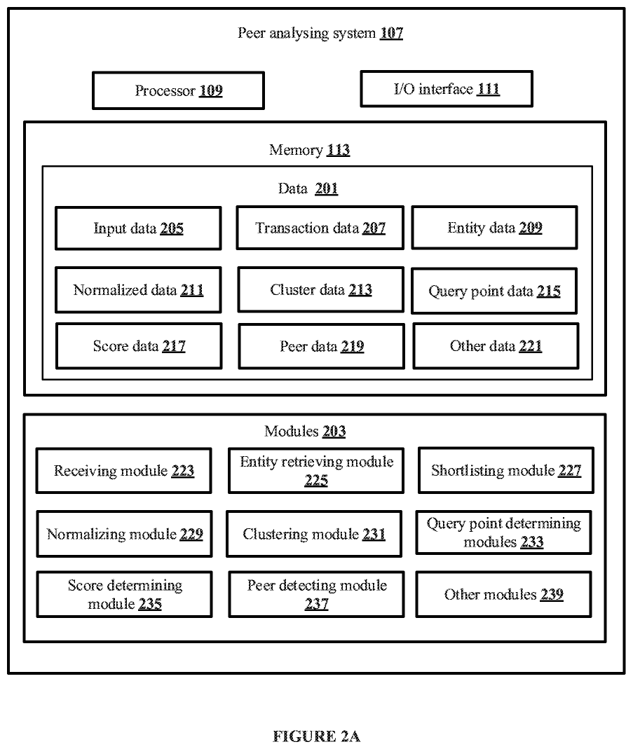

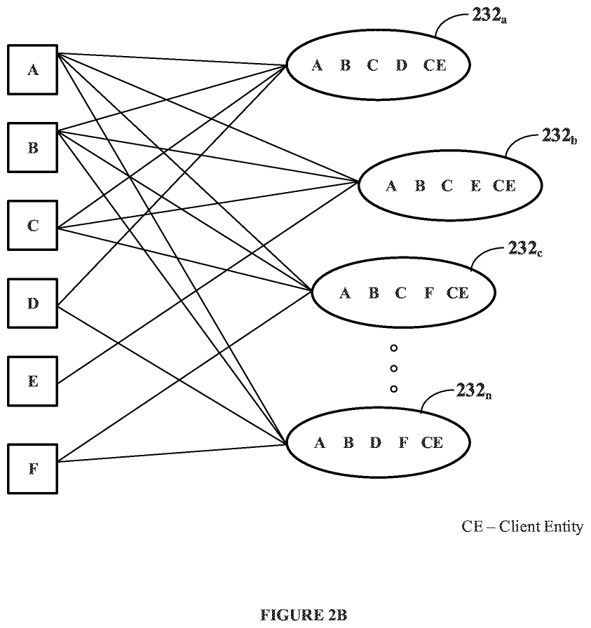

FIG. 2A shows a detailed block diagram of the peer analyzing system for detecting peers of a client entity, in accordance with some non-limiting embodiments or aspects of the present disclosure.

In some non-limiting implementations, the peer analyzing system 107 may include data 201 and modules 203. As an example, the data 201 may be stored in a memory 113 configured in the peer analyzing system 107 as shown in FIG. 2A. In some non-limiting embodiments or aspects, the data 201 may include input data 205, transaction data 207, entity data 209, normalized data 211, cluster data 213, query point data 215, score data 217, peer data 219, and other data 221. In the illustrated FIG. 2A, modules 203 are described herein in detail.

In some non-limiting embodiments or aspects, the data 201 may be stored in the memory 113 in the form of various data structures. Additionally, the data 201 can be organized using data models, such as relational or hierarchical data models. The other data 221 may store data, including temporary data and temporary files, generated by the modules 203 for performing the various functions of the peer analyzing system 107.

In some non-limiting embodiments or aspects, the data 201 stored in the memory 113 may be processed by the modules 203 of the peer analyzing system 107. The modules 203 may be stored within the memory 113. In an example, the modules 203 communicatively coupled to the processor 109 configured in the peer analyzing system 107 may also be present outside the memory 113 as shown in FIG. 2A and implemented as hardware. As used herein, the term modules 203 may refer to an application specific integrated circuit (ASIC), an electronic circuit, a processor (shared, dedicated, or group), and memory that execute one or more software or firmware programs, a combinational logic circuit, and/or other suitable components that provide the described functionality.

In some non-limiting embodiments or aspects, the modules 203 may include, for example, a receiving module 223, an entity retrieving module 225, a shortlisting module 227, a normalizing module 229, a clustering module 231, a query point determining module 233, a score determining module 235, a peer detecting module 237, and other modules 239. The other modules 239 may be used to perform various miscellaneous functionalities of the peer analyzing system 107. It will be appreciated that such aforementioned modules 203 may be represented as a single module or a combination of different modules.

In some non-limiting embodiments or aspects, the receiving module 223 may receive the input data 205 from a client entity 101. The client entity 101 may be an entity requesting the peer analyzing system 107 to detect one or more peers 115 of that entity. As an example, the input data 205 may include, but not be limited to, an entity ID of the client entity 101, an industry segment of the client entity 101, and a query of the client entity 101.

In some non-limiting embodiments or aspects, the entity retrieving module 225 may retrieve a plurality of target entities related to the input data 205 and the transaction data 207 related to the plurality of target entities, in real-time. In some non-limiting embodiments or aspects, the target entities may be potential peers of the client entity 101 in the industry segment of the client entity 101. In some non-limiting embodiments or aspects, the transaction data 207 comprises entity ID, entity name, entity category, transaction volume, transaction ID, ticket size, and card count. In some non-limiting embodiments or aspects, the transaction data 207 may be stored using an inverted index based storage system associated with the peer analyzing system 107.

In some non-limiting embodiments or aspects, the shortlisting module 227 may shortlist a predefined number of the plurality of target entities based on transaction volume of the corresponding target entity. As an example, consider the predefined number is 10. In such scenarios, the shortlisting module 227 may shortlist 10 target entities from the plurality of target entities retrieved by the entity retrieving module 225. In some non-limiting embodiments or aspects, the processor 109 may shortlist the plurality of target entities by sorting the plurality of target entities based on transaction volume related to the plurality of target entities. As an example, consider below Table 1, which shows a list of restaurants sorted based on transaction volume of each restaurant.

TABLE 1

| | Transaction | | | |
|---|---|---|---|---|
| Entity ID | Volume | Ticket Size | Card Count | Entity Name |
| 2026 | 347546 | 5110.970588 | 65 | A |
| 2024 | 326978 | 6055.148148 | 51 | B |
| 2029 | 300499 | 5181.017241 | 55 | C |
| 2025 | 286401 | 5728.02 | 46 | D |
| 2021 | 274806 | 4996.472727 | 52 | E |
| 2023 | 273040 | 6203.454545 | 42 | F |
| 2020 | 251285 | 5711.022727 | 40 | G |
| 2028 | 247284 | 5261.361702 | 44 | H |
| 2027 | 238460 | 5183.913043 | 45 | I |
| 2022 | 191428 | 4908.410256 | 37 | J |
| 2013 | 51833 | 647.9125 | 72 | K |
| 2012 | 37707 | 673.3392857 | 54 | L |
| 2018 | 31999 | 571.4107143 | 54 | M |
| 2011 | 31937 | 651.7755102 | 46 | N |

In the above Table 1, 14 restaurants are sorted based on their transaction volume in descending order. Since the predefined number is 10, the shortlisting module 227 may shortlist the first 10 restaurants in the sorted list for further processing, which means the restaurants bearing entity ID “2026” to “2022” in the Table 1 may be shortlisted. In some non-limiting embodiments or aspects, the shortlisted entities may be stored as the entity data 209.

In some non-limiting embodiments or aspects, the normalizing module 229 may determine normalized values of a plurality of parameters of the transaction data 207 for each of the shortlisted entities and the client entity 101. In some non-limiting embodiments or aspects, the processor 109 may determine the normalized values of the plurality of parameters for each of the shortlisted entities and the client entity 101 using one or more predefined min-max normalization techniques. In some non-limiting embodiments or aspects, the normalizing module 229 may determine normalized values of the plurality of parameters using the below Equation 1.

Zᵢ=Xᵢ−Min(X)/[Max(X)−Min(X)] Equation 1

In the above Equation 1, Zᵢ indicates the normalized values of a parameter; Xᵢ indicates the value of the parameter which requires normalization; Max(X) indicates the maximum value of the parameter which requires normalization; and Min(X) indicates the minimum value of the parameter which requires normalization.

As an example, consider the parameter that requires normalization is the transaction volume. Further, consider values of the transaction volume as shown in the above Table 1 for the top 10 shortlisted restaurants (entities). In view of the above Table 1, Xᵢ for restaurant bearing the ID “2026” is “347546”; Maximum value (Max(X)) of the parameter “transaction volume” among the shortlisted restaurants of Table 1 is “347546”; and Minimum value (Min(X)) of the parameter “transaction volume” among the shortlisted restaurants of Table 1 is “191428”.

Upon substituting the abovementioned values in Equation 1, the normalizing module 229 may determine the normalized values of the transaction volume for the restaurant bearing the ID “2026”. Similarly, the normalizing module 229 may determine the normalized values of the plurality of parameters of the transaction data 207 for each of the shortlisted entities. As an example, another parameter of the transaction data 207 of the shortlisted entities that may be considered for normalization may be “Ticket Size”. The normalized values of the plurality of parameters may be stored as the normalized data 211. In some non-limiting embodiments or aspects, a minimum two parameters of the transaction data 207 may be required for detecting one or more peers 115 of the client entity 101. Therefore, the normalizing module 229 may select a minimum two parameters for normalization and further processing. Hereinafter, the disclosure is explained considering the minimum two parameters required for detecting the one or more peers 115 of the client entity 101 as “Transaction Volume” and “Ticket Size”. However, this should not be construed as a limitation since any parameters and any number of parameters based on the required for detecting the one or more peers 115, based on the query of the client entity 101, may be used in this disclosure. In some non-limiting embodiments or aspects, the plurality of parameters required for normalization may be predefined. In some non-limiting embodiments or aspects, the plurality of parameters required for normalization may be dynamically selected by the normalizing module 229.

Further, in some non-limiting embodiments or aspects, the clustering module 231 may generate a plurality of clusters of the shortlisted entities by applying a predefined cluster compliance rule. As an example, the predefined cluster compliance rule may include, but not be limited to, Rule 5/50. In some non-limiting embodiments or aspects, each of the plurality of clusters may include a unique combination of the plurality of target entities shortlisted by the processor 109. In some non-limiting embodiments or aspects, the unique combination may be all permutations and combinations of the shortlisted entities that comply with the predefined cluster compliance rule. In some non-limiting embodiments or aspects, the plurality of clusters of the shortlisted entities may be generated using one or more clustering algorithms. As an example, the clustering algorithms may be unsupervised learning algorithms that perform clustering based on an upper bound of the plurality of parameters used for performing the peer analysis. In some non-limiting embodiments or aspects, the clusters of the shortlisted entities may be stored as the cluster data 213. As an example, consider the shortlisted restaurants as shown in the above Table 1. Consider, upon applying the Rule 5/50, shortlisted restaurants G, H, I, and J failed to comply with the rule. Therefore, the clustering module 231 may eliminate the shortlisted restaurants G, H, I, and J from the process of clustering. Further, the clustering module 231 may generate a plurality of clusters (232ₐ, 232_{b}, 232_{c}, up to 232ₙ) using the remaining shortlisted restaurants A, B, C, D, E, and F as shown in FIG. 2B. In an exemplary embodiment, the clustering module 231 may initially generate a plurality of clusters with each of the shortlisted entities in Table 1 and thereafter the clustering module 231 may eliminate non-compliant clusters from the plurality of clusters. In some non-limiting embodiments or aspects, the non-compliant clusters may be clusters that do not comply with a specific rule such as the predefined cluster compliance rule that defines criteria for selecting and eliminating the clusters.

Further, in some non-limiting embodiments or aspects, the query point determining module 233 may determine a query point of the plurality of parameters for each of the plurality of clusters based on the normalized values of the corresponding plurality of parameters determined for the client entity 101. In some non-limiting embodiments or aspects, the query point determining module 233 may determine the query point of the plurality of parameters for each of the plurality of clusters using the below Equation 2.

QP(i)=(1−0)*V(i) of the parameter of the client entity Equation 2

In the above Equation 2, QP(i) indicates Query point of a parameter “i”; and V(i) indicates normalized values of the parameter “i”.

As an example, consider the parameter for which the Query point needs to be determined is transaction volume. In such a scenario, the above Equation 2 becomes

QP(TV)=(1−0)*V(TV) of the client entity Equation 2

Wherein, QP(TV) indicates Query point of transaction volume; and “V(TV)” indicates normalized values of the transaction volume of the client entity 101.

As an example, consider the normalized values of the transaction volume of the client entity 101 is 100. Therefore, by substituting the value in the above Equation 2, the query point of the transaction volume determined for each of the plurality of clusters may be 100. Similarly, the query point determining module 233 may determine the query point for the parameter “ticket size” for each of the plurality of clusters. The query point of the plurality of parameters thus determined for each of the plurality of clusters may be stored as the query point data 215.

Further, in some non-limiting embodiments or aspects, the score determining module 235 may determine a relevance score and a proximity score of each of the plurality of clusters based on the query point of the plurality of parameters and the normalized values of the corresponding plurality of parameters determined for the client entity 101 and each of the shortlisted entities. In some non-limiting embodiments or aspects, the relevance score may indicate a degree of similarity of each of the plurality of clusters to the query of the client entity 101. The score determining module 235 may determine the relevance score by initially determining a mean deviation of the normalized values of the plurality of parameters for each of the plurality of clusters. In some non-limiting embodiments or aspects, the score determining module 235 may determine the mean deviation based on the normalized values of the plurality of parameters of each shortlisted entity in the plurality of clusters and the query point of the corresponding plurality of parameters. The score determining module 235 may determine the mean deviation of the normalized values of the plurality of parameters for each of the plurality of clusters using the below Equation 3.

Dᵢ=Σⱼ₌₁ⁿ(|Vᵢⱼ−V_{iq}|/n) Equation 3

In the above Equation 3, Dᵢ indicates mean deviation of the normalized values of the parameter i; j indicates shortlisted entities of the cluster; n indicates total number of shortlisted entities in the cluster; Vᵢⱼ indicates normalized values of the parameter i corresponding to j^{th} entity in the cluster; and W_{iq} indicates query point of the parameter i.

As an example, consider the parameter “i” is “transaction volume”. Further, consider each cluster of shortlisted entities comprises five shortlisted entities. In such scenario, the above Equation 3 becomes

D_{(TV)}=Σⱼ₌₁ⁿ⁼⁵(|V_{(TV)j}−V_{(TV)q}|/5) Equation 5

In the above Equation 3, D(TV) indicates mean deviation of the normalized values of the parameter “transaction volume”; j indicates shortlisted entities of the cluster; n=5 indicates total number of shortlisted entities in the cluster; V_{(TV)j} indicates normalized values of the parameter “transaction volume” corresponding to j^{th} entity in the cluster; and V_{(TV)q} indicates query point of the parameter “transaction volume”.

As an example, the score determining module 235 may similarly determine the mean deviation for the parameter “ticket size” for each of the plurality of clusters.

Upon determining the mean deviation of the normalized values of the plurality of parameters, the score determining module 235 may determine a weighted deviation by multiplying the mean deviation determined for each of the plurality of clusters with a corresponding weight. In some non-limiting embodiments or aspects, the score determining module 235 may dynamically assign weights for mean deviation of each of the plurality of clusters. In some non-limiting embodiments or aspects, the weights for the mean deviation of each of the plurality of clusters may be predefined. The score determining module 235 may determine the weighted deviation using the below Equation 4.

D=Σ [symbol] Wᵢ*Dᵢ [symbol] Equation 4

In the above Equation 4, D indicates weighted deviation; Wᵢ indicates weight assigned for mean deviation of the normalized values of parameter i for a particular cluster; and Dᵢ indicates mean deviation of the normalized values of parameter i for a particular cluster.

Upon determining the weighted deviation, the score determining module 235 may determine the relevance score for each of the plurality of clusters using the below Equation 5.

Relevance score=100−D Equation 5

In the above Equation 5, D indicates the weighted deviation. Since minimum two parameters are used for detecting the one or more peers 115 of the client entity 101, there would be minimum two weighted deviations corresponding to two parameters for each of the plurality of clusters. In such scenarios, the above Equation 5 may be generalized as shown in the below Equation 6.

$$Relevance score = 100 - {\sum }_{D = D 1}^{D = Dn} ( \frac{D}{n} ) \qquad Equation 6$$

In the above Equation 6, Dₙ indicates weighted deviation of normalized values of parameter n; and n indicates total number of parameters.

Further, the score determining module 235 may determine the proximity score for each of the plurality of clusters based on the normalized values of the plurality of parameters determined for the client entity 101 and each of the shortlisted entities. In some non-limiting embodiments or aspects, the proximity score may indicate degree of proximity of each of the plurality of clusters to the client entity 101. The score determining module 235 may determine the proximity score by initially determining a proximity value of the normalized values of the plurality of parameters for each of the plurality of clusters. In some non-limiting embodiments or aspects, the score determining module 235 may determine the proximity value of the normalized values of the plurality of parameters for each of the plurality of clusters using the below Equation 7.

Pᵢ=Σⱼ₌₁ⁿ(|Vᵢⱼ−Vᵢₘ|/n) Equation 7

In the above Equation 7, Pᵢ indicates proximity value of the normalized values of the parameter i; j indicates shortlisted entities of the cluster; n indicates total number of shortlisted entities in the cluster; Vᵢⱼ indicates normalized values of the parameter i corresponding to j^{th} entity in the cluster; and Vᵢₘ indicates normalized values of the parameter i of the client entity 101.

As an example, consider the parameter “i” is “transaction volume”. Further, consider each cluster of shortlisted entities comprises five shortlisted entities. In such scenario, the above Equation 3 becomes

P_{(TV)}=Σⱼ₌₁ⁿ⁼⁵(|V_{(TV)j}−V_{(TV)m}|/5) Equation 7

In the above Equation 7, P_{(TV)} indicates proximity value of the normalized values of the parameter “transaction volume”; j indicates shortlisted entities of the cluster; n=5 indicates total number of shortlisted entities in the cluster; V_{(TV)j} indicates normalized values of the parameter “transaction volume” corresponding to j^{th} entity in the cluster; and V_{(TV)m} indicates normalized values of the parameter “transaction volume” of the client entity 101.

As an example, the score determining module 235 may similarly determine the proximity value for the parameter “ticket size” for each of the plurality of clusters.

Upon determining the proximity value of the normalized values of the plurality of parameters, the score determining module 235 may determine a weighted proximity value by multiplying the proximity value determined for each of the plurality of clusters with a corresponding weight. In some non-limiting embodiments or aspects, the score determining module 235 may dynamically assign weights for the proximity value determined for each of the plurality of clusters. In some non-limiting embodiments or aspects, the weights for the proximity value determined for each of the plurality of clusters may be predefined. The score determining module 235 may determine the weighted deviation using the below Equation 8.

P=ΣWi*Pi Equation 8

In the above Equation 8, P indicates weighted proximity value; Wᵢ indicates weight assigned for the proximity value of the normalized values of parameter i for a particular cluster; and Pᵢ indicates proximity value of the normalized values of parameter i for a particular cluster.

Upon determining the weighted proximity value, the score determining module 235 may determine the proximity score for each of the plurality of clusters using the below Equation 9.

Proximity score=100−P Equation 9

In the above Equation 9, P indicates the weighted proximity value. Since minimum two parameters are used for detecting the one or more peers 115 of the client entity 101, there would be minimum of two weighted parameter values corresponding to two parameters for each of the plurality of clusters. In such scenarios, the above Equation 9 may be generalized as shown in the below Equation 10.

$$Proximity score = 100 - {\sum }_{P = P 1}^{P = Pn} ( \frac{D}{n} ) \qquad Equation 10$$

In the above Equation 10, Pn indicates weighted proximity value of the normalized values of parameter n; and n indicates total number of parameters.

In some non-limiting embodiments or aspects, the relevance score and the proximity score determined for each of the plurality of clusters may be stored as the score data 217.

Further, in some non-limiting embodiments or aspects, the peer detecting module 237 may detect one or more peers 115 of the client entity 101 based on the relevance score and the proximity score of each of the plurality of clusters. In some non-limiting embodiments or aspects, the peer detecting module 237 may detect a cluster of the shortlisted entities among the plurality of clusters based on the relevance score and proximity score of each of the plurality of clusters. In some non-limiting embodiments or aspects, the shortlisted entities that are part of the detected cluster may be considered as the one or more peers 115 of the client entity 101. In some non-limiting embodiments or aspects, the processor 109 may select the cluster of the shortlisted entities corresponding to highest relevance score and highest proximity score to detect the peers 115 of the client entity 101. In some other embodiments, the processor 109 may select the cluster of the shortlisted entities based on the query point of the plurality of parameters. In yet other embodiments, the processor 109 may be configured with a predefined threshold. In such scenarios, the processor 109 may select the cluster of the shortlisted entities corresponding to the relevance score and the proximity score which complies with the predefined threshold. The one or more peers 115 detected for the client entity 101 may be stored as the peer data 219.

In some non-limiting embodiments or aspects, the processor 109 may select the cluster of shortlisted entities based on the purpose of the peer analysis or based on query/requirements of the client entity. As an example, consider a scenario where a client entity “ABC” specifically wants to compare itself with a target entity “XYZ”. In such scenarios, the processor 109 may select the cluster of the shortlisted entities corresponding to the proximity score and the relevance score such that the target entity “XYZ” becomes a part of the selected cluster.

As an example, consider a scenario where the client entity “ABC” is a low level entity with a transaction volume of “X”. Consider the client entity “ABC” wishes to know its relative position with respect to the target entity “XYZ”, which is a high level entity having a transaction volume of “10(X)”, e.g., 10 times the transaction volume of the client entity “ABC”. Generally, when peer analysis is performed based on the transaction volume of the client entity “ABC”, the proximity score of the cluster comprising the target entity “XYZ” may be substantially low compared to proximity scores of other clusters, due to a large difference in the transaction volume between the client entity “ABC” and the target entity “XYZ”. Due to the low proximity score, generally, the processor 109 may not select the cluster comprising the target entity “XYZ” as the peer of the client entity “ABC”. However, since the query/requirement of client entity “ABC” is to know its relative position with respect to the target entity “XYZ”, the processor 109 may now select the cluster comprising the target entity “XYZ” as a peer of the client entity “ABC”. Therefore, in this scenario, the cluster comprising the target entity “XYZ” would have a highest degree of similarity to the query of the client entity “ABC”, which in turn may lead to a highest relevance score for the cluster comprising the target entity “XYZ”. Thus, in such scenarios, though the proximity score of the cluster comprising the target entity “XYZ” would be low compared to the proximity scores of the other clusters that do not include the target entity “XYZ”, the corresponding relevance score would be the highest. Thereafter, the processor 109 may select the cluster comprising the target entity “XYZ” itself as the peer of the client entity “ABC”. Therefore, in such scenarios, the processor 109 may apply the logic of selecting the cluster of the shortlisted entities having the highest relevance score, irrespective of the proximity score.

However, consider the same scenario as explained above, but the transaction volume of target entity is “2×”, e.g., 2 times the transaction volume of the client entity “ABC” instead of “10×”. In such scenarios, the proximity score of the cluster comprising the target entity “XYZ” may be high, compared to the proximity score of the other clusters since the target entity “XYZ” is proximal to the client entity “ABC” with respect to transaction volume. Further, since the query/requirement of client entity “ABC” is to know its relative position with respect to the target entity “XYZ”, relevance score of the cluster comprising the target entity “XYZ” may as well be high compared to relevance scores of the other clusters that do not include the target entity “XYZ”. Therefore, in such scenarios, the processor 109 may apply the logic of selecting the cluster of the shortlisted entities having the highest proximity score and the highest relevance score, when compared to the proximity score and the relevance score of the other clusters.

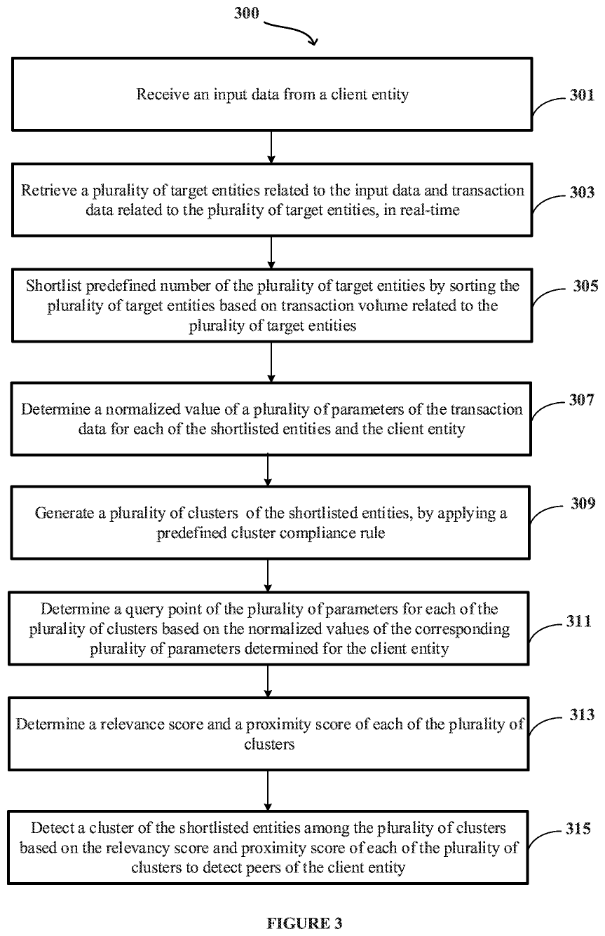

FIG. 3 shows a flow chart illustrating a method of detecting peers of a client entity in real-time, in accordance with some non-limiting embodiments or aspects of the present disclosure.

The order in which the method 300 is described is not intended to be construed as a limitation, and any number of the described method blocks can be combined in any order to implement the method 300. Additionally, individual blocks may be deleted from the methods without departing from the spirit and scope of the subject matter described herein. Furthermore, the method 300 can be implemented in any suitable hardware, software, firmware, or combination thereof.

At block 301, the method 300 may include receiving, by a processor 109 of a peer analyzing system 107, input data 205 from a client entity 101. In some non-limiting embodiments or aspects, the input data 205 comprises an entity ID, an industry segment of the client entity 101, and a query of the client entity 101.

At block 303, the method 300 may include retrieving, by the processor 109, a plurality of target entities related to the input data 205 and transaction data 207 related to the plurality of target entities, in real-time. In some non-limiting embodiments or aspects, the transaction data 207 may include, but not be limited to, entity ID, entity name, entity category, transaction volume, transaction ID, ticket size, and card count.

At block 305, the method 300 may include shortlisting, by the processor 109, a predefined number of the plurality of target entities by sorting the plurality of target entities based on transaction volume related to the plurality of target entities.

At block 307, the method 300 may include determining, by the processor 109, normalized values of a plurality of parameters of the transaction data 207 for each of the shortlisted entities and the client entity 101.

At block 309, the method 300 may include generating, by the processor 109, a plurality of clusters of the shortlisted entities by applying a predefined cluster compliance rule. In some non-limiting embodiments or aspects, each of the plurality of clusters comprises a unique combination of the shortlisted entities.

At block 311, the method 300 may include determining, by the processor 109, a query point of the plurality of parameters for each of the plurality of clusters based on the normalized values of the corresponding plurality of parameters determined for the client entity 101.

At block 313, the method 300 may include determining, by the processor 109, a relevance score and a proximity score of each of the plurality of clusters based on the query point of the plurality of parameters and the normalized values of the corresponding plurality of parameters determined for the client entity 101 and each of the shortlisted entities.

At block 315, the method 300 may include detecting, by the processor 109, a cluster of the shortlisted entities among the plurality of clusters based on the relevance score and proximity score of each of the plurality of clusters to detect peers 115 of the client entity 101.

The present disclosure enables detection of peers 115 for any entity using suitable quantifiable metrics in real-time.

Further, the present disclosure generates the plurality of clusters of target entities based on real-time transaction data 207 such that every possible unique combination of the target entities is covered, while adhering to the predefined cluster compliance rule. Therefore, this feature of the present disclosure enables accurate detection of peers 115 of the client entity 101 in real-time.

Further, the present disclosure performs query based detection of peers 115, which means that the present disclosure enables the client entity 101 to provide their specific requirements in the form of a query for performing the peer analysis. Therefore, the present disclosure is flexible to cater different requirements of the client entities while performing the peer analysis, in real-time.

Further, the present disclosure may be adaptable to generate clusters of customizable sizes based on the requirement of the client entity 101 by analyzing the transaction data 207 in real-time.

Further, the present disclosure determines the peers 115 of the client entity 101 based on both relevance score and proximity score, thereby detecting the most accurate peers 115 of the client entity 101 in view of the degree of similarity of the plurality of clusters to query of the client entity 101 and the degree of proximity of the plurality of clusters to client entity 101.

Further, the present disclosure enables peer selection per an individual cluster or combination of different clusters.

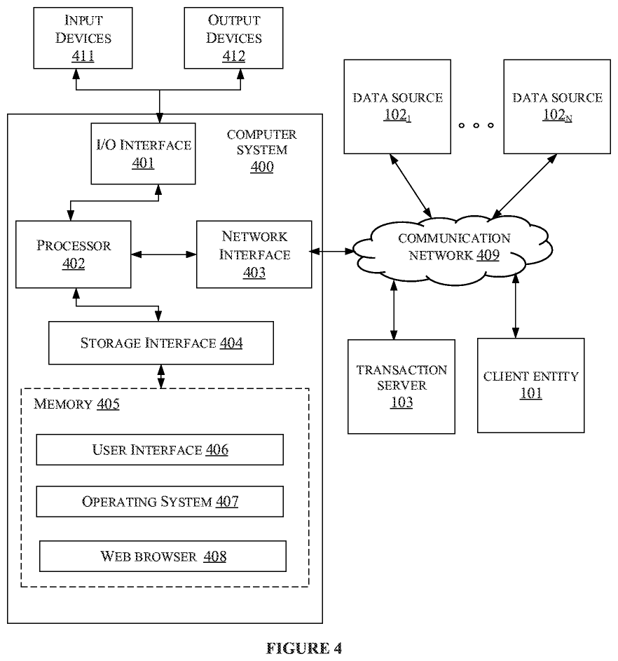

FIG. 4 is a block diagram of an exemplary computer system for implementing embodiments consistent with the present disclosure.

In some non-limiting embodiments or aspects, FIG. 4 illustrates a block diagram of an exemplary computer system 400 for implementing embodiments consistent with the present disclosure. In some non-limiting embodiments or aspects, the computer system 400 can be peer analyzing system 107 that is used for detecting peers 115 of a client entity 101 in real-time. The computer system 400 may include a central processing unit (“CPU” or “processor”) 402. The processor 402 may include at least one data processor for executing program components for executing user or system-generated business processes. A user may include a person, a person using a device such as those included in this disclosure, or such a device itself. The processor 402 may include specialized processing units such as integrated system (bus) controllers, memory management control units, floating point units, graphics processing units, digital signal processing units, etc.

The processor 402 may be disposed in communication with input devices 411 and output devices 412 via I/O interface 401. The I/O interface 401 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth®, cellular (e.g., Code-Division Multiple Access (CDMA), High-Speed Packet Access (HSPA+), Global System For Mobile Communications (GSM), Long-Term Evolution (LTE), WiMax, or the like), etc.

Using the I/O interface 401, the computer system 400 may communicate with the input devices 411 and the output devices 412.

In some non-limiting embodiments or aspects, the processor 402 may be disposed in communication with a communication network 409 via a network interface 403. The network interface 403 may communicate with the communication network 409. The network interface 403 may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc. Using the network interface 403 and the communication network 409, the computer system 400 may communicate with a client entity 101, one or more data sources 102 and a transaction server 103. The communication network 409 can be implemented as one of the different types of networks, such as intranet or Local Area Network (LAN), Closed Area Network (CAN) and such. The communication network 409 may either be a dedicated network or a shared network, which represents an association of the different types of networks that use a variety of protocols, for example, Hypertext Transfer Protocol (HTTP), CAN Protocol, Transmission Control Protocol/Internet Protocol (TCP/IP), Wireless Application Protocol (WAP), etc., to communicate with each other. Further, the communication network 409 may include a variety of network devices, including routers, bridges, servers, computing devices, storage devices, etc. In some non-limiting embodiments or aspects, the processor 402 may be disposed in communication with a memory 405 (e.g., RAM, ROM, etc. not shown in FIG. 4) via a storage interface 404. The storage interface 404 may connect to memory 405 including, without limitation, memory drives, removable disc drives, etc., employing connection protocols such as Serial Advanced Technology Attachment (SATA), Integrated Drive Electronics (IDE), IEEE-1394, Universal Serial Bus (USB), fibre channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 405 may store a collection of program or database components, including, without limitation, a user interface 406, an operating system 407, a web browser 408 etc. In some non-limiting embodiments or aspects, the computer system 400 may store user/application data, such as the data, variables, records, etc. as described in this disclosure. Such databases may be implemented as fault-tolerant, relational, scalable, secure databases such as Oracle or Sybase.

The operating system 407 may facilitate resource management and operation of the computer system 400. Examples of operating systems include, without limitation, APPLE® MACINTOSH® OS X®, UNIX®, UNIX-like system distributions (E.G., BERKELEY SOFTWARE DISTRIBUTION® (BSD), FREEBSD®, NETBSD®, OPENBSD, etc.), LINUX® DISTRIBUTIONS (E.G., RED HAT®, UBUNTU®, KUBUNTU®, etc.), IBM®OS/2®, MICROSOFT® WINDOWS® (XP®, VISTA®/7/8, 10 etc.), APPLE® IOS®, GOOGLE™ ANDROID™, BLACKBERRY® OS, or the like. The User interface 406 may facilitate display, execution, interaction, manipulation, or operation of program components through textual or graphical facilities. For example, user interfaces may provide computer interaction interface elements on a display system operatively connected to the computer system 400, such as cursors, icons, checkboxes, menus, scrollers, windows, widgets, etc. Graphical User Interfaces (GUIs) may be employed, including, without limitation, Apple® Macintosh® operating systems' Aqua®, IBM® OS/2®, Microsoft® Windows® (e.g., Aero, Metro, etc.), web interface libraries (e.g., ActiveX®, Java®, Javascript®, AJAX, HTML, Adobe® Flash®, etc.), or the like.

In some non-limiting embodiments or aspects, the computer system 400 may implement the web browser 408 stored program components. The web browser 408 may be a hypertext viewing application, such as MICROSOFT® INTERNET EXPLORER®, GOOGLE™ CHROME™, MOZILLA® FIREFOX®, APPLE® SAFARI®, etc. Secure web browsing may be provided using Secure Hypertext Transport Protocol (HTTPS), Secure Sockets Layer (SSL), Transport Layer Security (TLS), etc. Web browsers 408 may utilize facilities such as AJAX, DHTML, ADOBE® FLASH®, JAVASCRIPT®, JAVA®, Application Programming Interfaces (APIs), etc. In some non-limiting embodiments or aspects, the computer system 400 may implement a mail server stored program component. The mail server may be an Internet mail server such as Microsoft Exchange, or the like. The mail server may utilize facilities such as Active Server Pages (ASP), ACTIVEX®, ANSI® C++/C#, MICROSOFT®, .NET, CGI SCRIPTS, JAVA®, JAVASCRIPT®, PERL®, PHP, PYTHON®, WEBOBJECTS®, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some non-limiting embodiments or aspects, the computer system 400 may implement a mail client stored program component. The mail client may be a mail viewing application, such as APPLE® MAIL, MICROSOFT® ENTOURAGE®, MICROSOFT® OUTLOOK®, MOZILLA® THUNDERBIRD®, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, e.g., non-transitory. Examples include Random Access Memory (RAM), Read-Only Memory (ROM), volatile memory, non-volatile memory, hard drives, Compact Disc (CD) ROMs, Digital Video Disc (DVDs), flash drives, disks, and any other known physical storage media.

The terms “including”, “comprising”, “having”, and variations thereof mean “including but not limited to”, unless expressly specified otherwise.

The enumerated listing of items does not imply that any or all of the items are mutually exclusive, unless expressly specified otherwise. The terms “a”, “an”, and “the” mean “one or more”, unless expressly specified otherwise.

A description of some non-limiting embodiments or aspects with several components in communication with each other does not imply that all such components are required. On the contrary, a variety of optional components is described to illustrate the wide variety of possible embodiments of the disclosure.

When a single device or article is described herein, it may be readily apparent that more than one device/article (whether or not they cooperate) may be used in place of a single device/article. Similarly, where more than one device or article is described herein (whether or not they cooperate), it may be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the disclosure need not include the device itself.

The illustrated operations of FIG. 3 show certain events occurring in a certain order. In alternative embodiments, certain operations may be performed in a different order, modified, or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based here on. Accordingly, the disclosure of the embodiments of the disclosure is intended to be illustrative, but not limiting, of the scope of the disclosure, which is set forth in the following claims.

While various aspects and embodiments have been disclosed herein, other aspects and embodiments may be apparent to those skilled in the art. The various aspects and embodiments disclosed herein are for purposes of illustration and are not intended to be limiting, with the true scope and spirit being indicated by the following claims.

What is claimed is:

1. A computer-implemented method comprising:
receiving, by a peer analyzing system, input data from a client entity, wherein the input data comprises an entity ID, an industry segment of the client entity, and a query of the client entity;
retrieving, by the peer analyzing system, a plurality of target entities related to the input data and transaction data related to the plurality of target entities, in real-time, wherein the transaction data comprises entity ID, entity name, entity category, transaction volume, transaction ID, ticket size, and card count;
shortlisting, by the peer analyzing system, a predefined number of the plurality of target entities by sorting the plurality of target entities based on transaction volume related to the plurality of target entities;
determining, by the peer analyzing system, normalized values of a plurality of parameters of the transaction data for each of the shortlisted entities and the client entity;
generating, by the peer analyzing system, a plurality of clusters of the shortlisted entities, by applying a predefined cluster compliance rule, wherein each of the plurality of clusters comprises a unique combination of the shortlisted entities;
determining, by the peer analyzing system, a query point of the plurality of parameters for each of the plurality of clusters based on the normalized values of the corresponding plurality of parameters determined for the client entity;
determining, by the peer analyzing system, a relevance score and a proximity score of each of the plurality of clusters based on the query point of the plurality of parameters and the normalized values of the corresponding plurality of parameters determined for the client entity and each of the shortlisted entities; and
detecting, by the peer analyzing system, a cluster of the shortlisted entities among the plurality of clusters based on the relevance score and the proximity score of each of the plurality of clusters to detect peers of the client entity.

2. The computer-implemented method as claimed in claim 1, wherein determining the relevance score comprises:
determining, by the peer analyzing system, a mean deviation of the normalized values of the plurality of parameters for each of the plurality of clusters based on the normalized values of the plurality of parameters of each shortlisted entity in the plurality of clusters and the query point of the corresponding plurality of parameters; and
determining, by the peer analyzing system, the relevance score for each of the plurality of clusters based on the mean deviation of the normalized values of the plurality of parameters determined for each of the plurality of clusters.

3. The computer-implemented method as claimed in claim 1, wherein determining the proximity score comprises:
determining, by the peer analyzing system, a proximity value of the normalized values of the plurality of parameters for each of the plurality of clusters based on the normalized values of the corresponding plurality of parameters of each target entity in the plurality of clusters and the normalized values of the corresponding plurality of parameters of the client entity; and
determining, by the peer analyzing system, the proximity score for each of the plurality of clusters based on the proximity value determined for each of the plurality of clusters.

4. The computer-implemented method as claimed in claim 1, wherein the relevance score indicates degree of similarity of each of the plurality of clusters to the query of the client entity.

5. The computer-implemented method as claimed in claim 1, wherein the proximity score indicates degree of proximity of each of the plurality of clusters to the client entity.

6. The computer-implemented method as claimed in claim 1, wherein the query of the client entity comprises a location of the client entity and time range for the query.

7. The computer-implemented method as claimed in claim 1, wherein the normalized values of the plurality of parameters for each of the shortlisted entities and the client entity is determined using one or more predefined min-max normalization techniques.

8. A peer analyzing system comprising:
a processor; and
a memory communicatively coupled to the processor, wherein the memory stores processor instructions, which, on execution, causes the processor to:
receive input data from a client entity, wherein the input data comprises an entity ID, an industry segment of the client entity, and a query of the client entity;
retrieve a plurality of target entities related to the input data and transaction data related to the plurality of target entities, in real-time, wherein the transaction data comprises entity ID, entity name, entity category, transaction volume, transaction ID, ticket size, and card count;
shortlist a predefined number of the plurality of target entities by sorting the plurality of target entities based on transaction volume related to the plurality of target entities;
determine normalized values of a plurality of parameters of the transaction data for each of the shortlisted entities and the client entity;
generate a plurality of clusters of the shortlisted entities, by applying a predefined cluster compliance rule, wherein each of the plurality of clusters comprises a unique combination of the shortlisted entities;
determine a query point of the plurality of parameters for each of the plurality of clusters based on the normalized values of the corresponding plurality of parameters determined for the client entity;
determine a relevance score and a proximity score of each of the plurality of clusters based on the query point of the plurality of parameters and the normalized values of the corresponding plurality of parameters determined for the client entity and each of the shortlisted entities; and
detect a cluster of the shortlisted entities among the plurality of clusters based on the relevance score and the proximity score of each of the plurality of clusters to detect peers of the client entity.

9. The peer analyzing system as claimed in claim 8, wherein the processor determines the relevance score by:
determining a mean deviation of the normalized values of the plurality of parameters for each of the plurality of clusters based on the normalized values of the plurality of parameters of each shortlisted entity in the plurality of clusters and the query point of the corresponding plurality of parameters; and
determining the relevance score for each of the plurality of clusters based on the mean deviation of the normalized values of the plurality of parameters determined for each of the plurality of clusters.

10. The peer analyzing system as claimed in claim 8, wherein the processor determines the proximity score by:
determining a proximity value of the normalized values of the plurality of parameters for each of the plurality of clusters based on the normalized values of the corresponding plurality of parameters of each target entity in the plurality of clusters and the normalized values of the corresponding plurality of parameters of the client entity; and
determining the proximity score for each of the plurality of clusters based on the proximity value determined for each of the plurality of clusters.

11. The peer analyzing system as claimed in claim 8, wherein the relevance score indicates degree of similarity of each of the plurality of clusters to the query of the client entity.

12. The peer analyzing system as claimed in claim 8, wherein the proximity score indicates degree of proximity of each of the plurality of clusters to the client entity.

13. The peer analyzing system as claimed in claim 8, wherein the query of the client entity comprises a location of the client entity and time range for the query.

14. The peer analyzing system as claimed in claim 8, wherein the normalized values of the plurality of parameters for each of the shortlisted entities and the client entity is determined using one or more predefined min-max normalization techniques.

15. A non-transitory computer readable medium including instructions stored thereon that when processed by at least one processor causes a peer analyzing system to perform operations comprising:
receiving input data from a client entity, wherein the input data comprises an entity ID, an industry segment of the client entity, and a query of the client entity;
retrieving a plurality of target entities related to the input data and transaction data related to the plurality of target entities, in real-time, wherein the transaction data comprises entity ID, entity name, entity category, transaction volume, transaction ID, ticket size, and card count;
shortlisting a predefined number of the plurality of target entities by sorting the plurality of target entities based on transaction volume related to the plurality of target entities;
determining normalized values of a plurality of parameters of the transaction data for each of the shortlisted entities and the client entity;
generating a plurality of clusters of the shortlisted entities, by applying a predefined cluster compliance rule, wherein each of the plurality of clusters comprises a unique combination of the shortlisted entities;
determining a query point of the plurality of parameters for each of the plurality of clusters based on the normalized values of the corresponding plurality of parameters determined for the client entity;
determining a relevance score and a proximity score of each of the plurality of clusters based on the query point of the plurality of parameters and the normalized values of the corresponding plurality of parameters determined for the client entity and each of the shortlisted entities; and
detecting a cluster of the shortlisted entities among the plurality of clusters based on the relevance score and the proximity score of each of the plurality of clusters to detect peers of the client entity.

16. The medium as claimed in claim 15, wherein the instructions cause the processor to determine the relevance score by:
determining a mean deviation of the normalized values of the plurality of parameters for each of the plurality of clusters based on the normalized values of the plurality of parameters of each shortlisted entity in the plurality of clusters and the query point of the corresponding plurality of parameters; and
determining the relevance score for each of the plurality of clusters based on the mean deviation of the normalized values of the plurality of parameters determined for each of the plurality of clusters.

17. The medium as claimed in claim 15, wherein the instructions cause the processor to determine the proximity score by:
determining a proximity value of the normalized values of the plurality of parameters for each of the plurality of clusters based on the normalized values of the corresponding plurality of parameters of each target entity in the plurality of clusters and the normalized values of the corresponding plurality of parameters of the client entity; and
determining the proximity score for each of the plurality of clusters based on the proximity value determined for each of the plurality of clusters.

18. The medium as claimed in claim 15, wherein the relevance score indicates degree of similarity of each of the plurality of clusters to the query of the client entity.

19. The medium as claimed in claim 15, wherein the proximity score indicates degree of proximity of each of the plurality of clusters to the client entity.

20. The medium as claimed in claim 15, wherein the query of the client entity comprises a location of the client entity and time range for the query.
